(19) United States
(12) Patent Application Publication
(10) Pub. No.: US 2003/0185498 A1
(43) Pub. Date: Oct. 2, 2003

(54) Optical switch

(76) Inventor: Mingbao Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/334,497

(22) Filed: Dec. 31, 2002

(30) Foreign Application Priority Data
Mar. 29, 2002 (TW) 91204041

(51) Int. Cl. G02B 6/35

(52) U.S. Cl. 385/22

(57) ABSTRACT

An optical switch according to the present invention, includes an input device (100) having an input fiber (120) received therein, an output device (200) having a plurality of output fibers (220) received therein, an optical switch device (300) which includes a prism array (310) consisting of a plurality of prisms, and a driving device (400). The driving device drives the switch device to move back and forth, selectively locating a specific prism of the prism array in an optical path between the input device and the output device, for selectably transferring an input light beam from the input fiber to a specific output fiber.

### CROSS-REFERENCE TO RELATED APPLICATION

This application is related to a co-pending application Ser. No. 10/295,091, entitled “OPTICAL SWITCH”, invented by the same inventor and assigned to the same assignee as this application. The disclosure of the related application is wholly incorporated herein by reference.

### BACKGROUND OF THE INVENTION

1. Field of the invention

The present invention relates to optical switches and, more particularly, to a mechanically actuated optical switch having a movable array of prisms which switches a light beam from an input fiber among a plurality of output fibers.

2. Description of Related Art

Optical switches of various kinds are well known for selectably switching light from one optical fiber or light-conducting path to another. In a 1XN optical switch, a single optical fiber forms an optical path with an optical fiber selected from N optical fibers. Thus a signal in the single optical fiber is transmitted to the selected fiber. Similarly a signal in the selected fiber can be transmitted to the single optical fiber in a reverse direction. A switch allows the optical connection to be changed from the selected fiber to another of the N fibers.

A conventional 1XN optical switch is disclosed in U.S. Pat. No. 5,867,617. Referring to FIG. 6, the optical switch includes an input assembly 600, four output assemblies 610, three prisms 650, a control device 660 and a hold assembly 670. The input assembly 600 includes an input fiber 601 and a self-focusing collimator lens 602. Each output assembly 610 has the same structure and includes an output fiber 611 and a self-focusing collimator lens 612. The control device 660 includes three arms 661, three drive portion 662 and a control circuit 663. One end (not labeled) of each arm 661 connects with a respective prism 650 and the prism 650 can move upwardly and downwardly through the engagement of the control circuit 663, the drive portion 662 and the arm 661, whereby the light path can be switched according to whether the prism 650 is in the light path or is removed from the light path. The hold assembly 670 includes a base 672 and a holding portion 671, wherein the holding portion 671 is adapted to mount the input assembly 600 and the output assemblies 610 thereon.

However, the four output assemblies 610 are spaced apart and each output assembly 610 includes not only an output fiber 611, but also a self-focusing collimator lens 612, which results in the optical switch having a complicated structure and a high cost of manufacture. In addition, if the number of output ports increases, light signals will have to pass through a plurality of prisms to achieve the switching function. The switch process will thus become more complicated, and the switching speed will in turn be reduced.

Thus, an improved optical switch is desirable to overcome the problems mentioned above.

### SUMMARY OF THE INVENTION

An object of the present invention is to provide an optical switch having a compact structure.

Another object of the present invention is to provide an optical switch which is inexpensive.

To achieve the above objects, an optical switch in accordance with the present invention includes an input device having an input fiber received therein, an output device having a plurality of output fibers received therein, an optical switch device which includes a prism array consisting of a plurality of prisms, and a driving device. The driving device drives the switch device to move back and forth thereby selectively locating a specific prism from the prism array in an optical path between the input device and the output device. Thus an input light beam from the input fiber is selectively switched among the output fibers.

Further objects and advantages of the present invention will become more apparent from a consideration of the drawings and the following detailed description.

### BRIEF DESCRIPTION OF THE DRAWINGS

FIG. 1 is a perspective view of an optical switch in accordance with the present invention;

FIG. 2 is a cross-sectional view of the optical switch of FIG. 1 taken along line II-II, but without a driving device;

FIG. 3 is a cross-sectional view of the optical switch of FIG. 1 taken along line III-III;

FIG. 4 is a schematic view of an optical path between an input device and an output device of the optical switch of FIG. 1;

FIG. 5 is a schematic view of another optical path between an input device and an output device of the optical switch of FIG. 1; and

FIG. 6 is a top view of an optical switch of the prior art.

### DETAILED DESCRIPTION OF THE PREFERRED EMBODIMENT

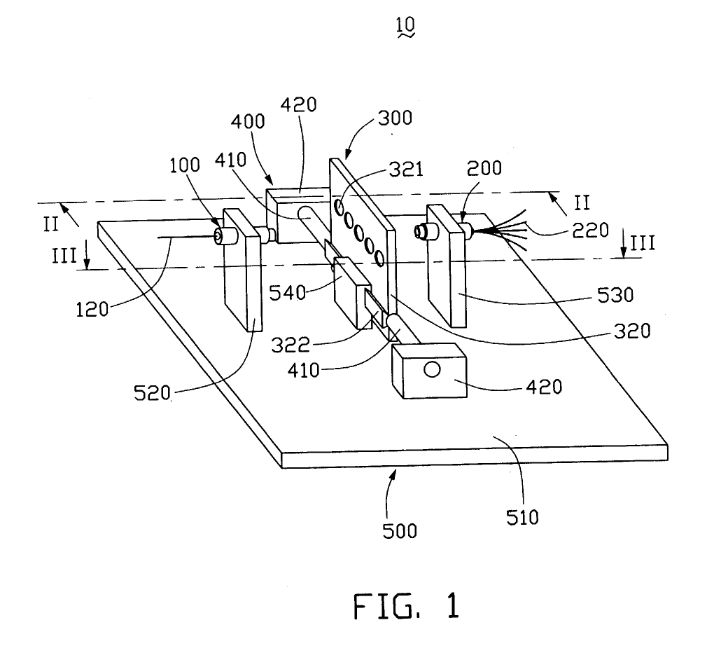

Referring to FIG. 1, an optical switch 10 according to a preferred embodiment the present invention includes an input device 100 having an input fiber 120, an output device 200 having a plurality of output fibers 220, an optical path switch device 300 and a driving device 400. A substrate 500 is used for supporting the aforesaid devices. The substrate 500 includes a base 510 and a first mounting plate 520 and a second mounting plate 530 respectively extending upwardly from the base 510, and a mounting block 540 disposed between the first and second mounting plates 520, 530.

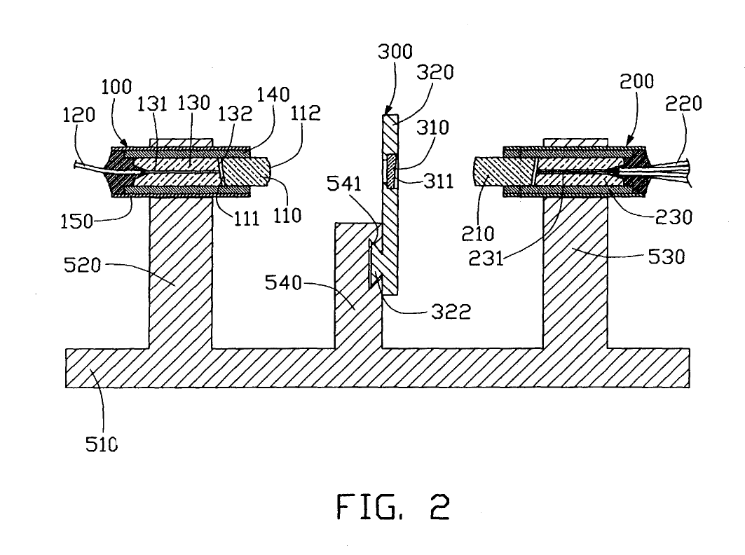

Referring to FIG. 2, the input device 100 is fixed on the first mounting plate 520 and includes a molded first collimator lens 110 and an input ferrule 130. The first collimator lens 110 is adapted to collimate a light beam (not shown) from the input fiber 120 and transmit the light beam to the switch device 300. Alternatively, the molded first collimator lens 110 can be replaced by other collimator lens designs which have a collimating function, for instance, a self-focusing collimator lens. The input ferrule 130 is cylindrical and defines a first through hole 131 for receiving the input fiber 120 therein. A forward end face 132 of the input ferrule 130 and an end face (not labeled) of the input fiber 120 adjacent the first collimator lens 110 are slant-polished together so that the tip of the input fiber 120 does not terminate with an end surface perpendicular to the longitudinal axis of the fiber 120. Typically, these end faces form an angle of between about 6 degrees and 8 degrees with a plane constructed perpendicular to the longitudinal axis of the fiber 120. A rearward face 111 of the first collimator lens 110 adjacent the input ferrule 130 is reciprocally slant-polished at substantially the same angle as the ferrule 130 and the fiber 120. The forward face 112 of the first collimator lens 110 is aspherical. The input ferrule 130 and the first collimator lens 110 are received in a quartz sleeve 140. The quartz sleeve 140 is further received in a metal ferrule 150 for providing a better protection to the input device 100.

The output device 200 is fixed on the second mounting plate 530 and includes a molded second collimator lens 210 and an output ferrule 230. The second collimator lens 210 is adapted to focus a light beam (not shown) from the switch device 300 to one of the output fiber 220. Alternatively, the second collimator lens 210 can be replaced by other collimator lens designs which have a focusing function, for instance, a self-focusing collimator lens. The output ferrule 230 is cylindrical and defines a second through hole 231 for receiving a plurality of output fibers 220 therein. The other structures of the output device 200 are similar to those of the input device 100 so a detailed description thereof is omitted here.

Simultaneously referring to FIGS. 1 and 2, the switch device 300 is moveably engaged with the mounting block 540 and includes a prism array 310 and a mounting panel 320 for holding the prism array 310. The prism array 310 includes a plurality of prisms which are used for bending light beams from the input device 100 so that, in passing through the second collimator lens 210, the light beam is focused to a specific output fiber 220. The specific output fiber being predetermined by the specific prism through which the light passed. Each prism has a slanted face 311 and each slanted face 311 is slanted at a different angle. The mounting panel 320 defines a plurality of mounting holes 321 for receiving the prism array 310 and forms a protrusion 322 for engaging with a groove 541 formed in the mounting block 540, thereby moveably engaging the switch device 300 with the substrate 500.

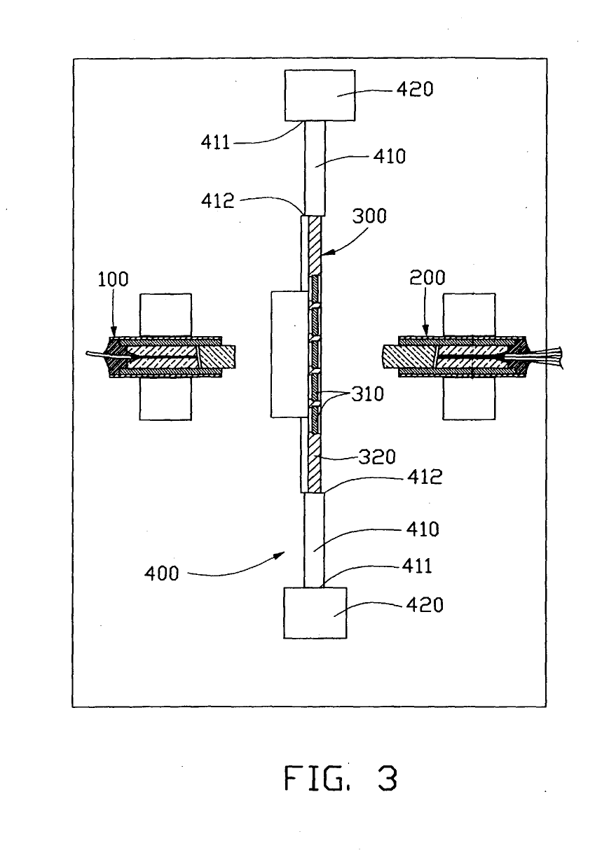

Referring to FIG. 3, the driving device 400 includes a pair of driving rods 410 and a pair of base portions 420. Both driving rods 410 are cylindrical and driven by an external device (not shown). An outward end 411 of each driving rod 410 connects to a corresponding base portion 420 and an inward end 412 connects to a corresponding side of the mounting panel 320.

In assembly, the input and output devices 100, 200, the switch device 300 and the driving device 400 are arranged on the substrate 500. The input device 100 is aligned with the output device 200. The switch device 300 is disposed between the input and output devices and moves in a line perpendicular to an axis of the aligned the input and output devices. The protrusion 322 formed on the mounting panel 320 is slidably received in the groove 541. Opposite lateral sides of the mounting panel 320 are connected to respective driving rods 410. Each prism 310 is mounted at a same height above the base 510 as that of the first and second collimator lenses 110, 210.

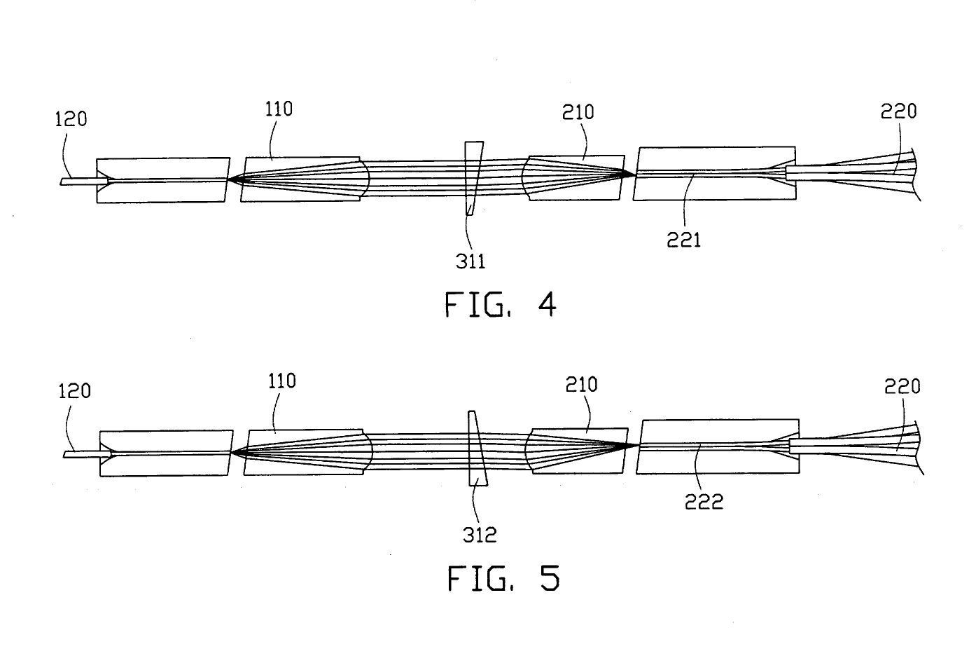

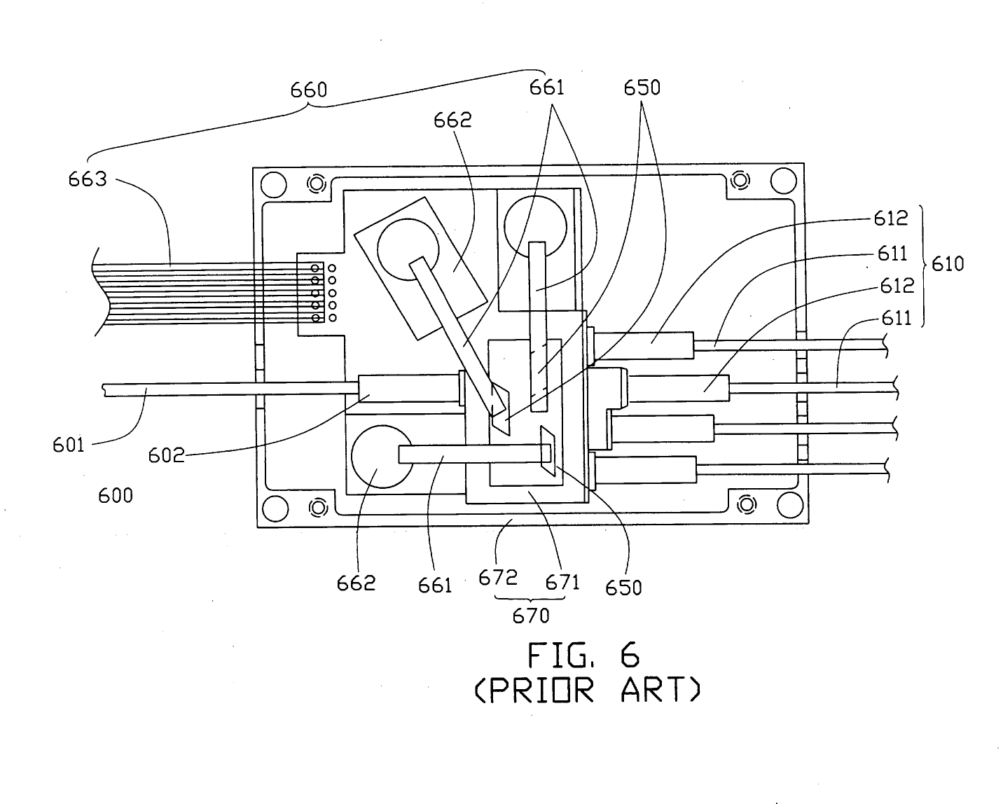

In operation, referring to FIG. 4, the external device drives the pair of rods 410 to drive the mounting panel 320 to move along the groove 541. As the mounting panel 320 moves, the prisms of the prism array 310 in turn intersect an optical path between the input device 100 and the output device 200. A light beam from the input fiber 120 is collimated to parallel light beams by the molded first collimator lens 110. These parallel light beams pass, for instance, through a prism 3101, which bends and transmits the light to the molded second collimator lens 210. The bending of the light is due to the refraction of the prism 3101. The second collimator lens 210 focuses the beams to an output fiber 221. Referring to FIG. 5, when the mounting panel 320 is moved so that a prism 3102 aligns with the optical path between the input and output devices 100, 200, the input light beams are bent by the prism 3102 and focus on an output fiber 222, whereby a switching of the optical paths between the input fiber 120 and the output fiber 220 is achieved. In the drawings five prisms are shown; in practice, a different number of prisms can be incorporated in the optical switch 10.

It is obvious that the optical switch of the present invention can accomplish switching of an optical path between an input fiber 120 and different output fibers 220. Since the optical paths are reversible, a light signal may also be transmitted from one of the output fibers 220 to the input fiber 120.

In comparison with the prior art, the output device 200 of the optical switch 10 of the present invention includes only one second collimator lens 210 and one output ferrule 230 with a plurality of output fibers 220 inserted therein. The number of collimator lenses used is, therefore, reduced in comparison with the prior art so that the cost is decreased and the optical switch achieves a more compact structure. Moreover, with the aid of the pair of rods 410, the driving device 400 drives the mounting panel 320 to move, allowing selection of a prism of the prism array 310 for insertion in the optical path between the input fiber 120 and the output devices 200, allowing selection of a specific output fiber 220. The switching process is thus simple, and the switching speed is increased.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. An optical switch comprising:
an input device including an input ferrule with an input fiber inserted therein and a first collimator lens for collimating an input beam from the input fiber;
an output device including an output ferrule with a plurality of output fibers inserted therein and a second collimator lens for focusing the collimated beam into one of the output fibers;
a switch device including a prism array arranged between the input device and the output device for bending the beam from the input fiber and transmitting the beam to the output device, the prism array including a plurality of prisms; and
a driving device for moving the switch device;
wherein the driving device drives the switch device to move from side to side for locating a specific prism of the prism array in an optical path between the input device and the output device, for selectably transferring an input light beam from the input fiber to a specific output fiber.

2. The optical switch as claimed in claim 1, wherein the first and second collimator lenses are molded collimator lens.

3. The optical switch as claimed in claim 1, wherein the first collimator lens has an aspherical face and the second collimator lens has a spherical face.

4. The optical switch as claimed in claim 1, wherein the switch device further includes a mounting panel for holding the prism array.

5. The optical switch as claimed in claim 4, wherein the mounting panel defines a plurality of mounting holes for holding the plurality of prisms of the prism array.

6. The optical switch as claimed in claim 1, wherein the driving device includes a pair of drive rods for connecting with the switch device and a pair of base portions for mounting the rods.

7. The optical switch as claimed in claim 1, further including a substrate for supporting the input device, the output device, the switch device and the driving device.

8. The optical switch as claimed in claim 7, wherein the substrate further includes a first and second mounting plate for holding the input and output device respectively, and a mounting block for holding the switch device.

9. The optical switch as claimed in claim 1, wherein each prism has a slant face and each slant face is slanted at a different angle.

10. An optical switch comprising:
an input device including an input ferrule with an input fiber inserted therein and a first collimator lens for collimating an input beam from the input fiber;
an output device including an output ferrule with a plurality of output fibers inserted therein and a second collimator lens for focusing the collimated beam into one of the output fibers;
a switch device including a prism array arranged between the input device and the output device for bending the beam from the input fiber and transmitting the beam to the output device, the prism array including a plurality of prisms; and
a driving device for moving the switch device;
wherein the driving device drives the switch device to move linearly for locating a specific prism of the prism array in an optical path between the input device and the output device, for selectably transferring an input light beam from the input fiber to a specific output fiber.
